(19) United States
(12) Patent Application Publication
(10) Pub. No.: US 2008/0164972 A1
(43) Pub. Date: Jul. 10, 2008

(54) Remote Operation Apparatus and Service Center

(76) Inventors: Naoki Taki, Aichi (JP); Atsushi Watanabe, Aichi (JP); Hidekazu Ito, Aichi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/884,952

(22) PCT Filed: May 24, 2006
(86) PCT No.: PCT/JP06/10836

§ 371 Date: Aug. 23, 2007

(30) Foreign Application Priority Data
Jun. 15, 2005 (JP) 2005-175289

(51) Int. Cl. G05B 23/02

(52) U.S. Cl. 340/3.1

(57) ABSTRACT

A remote operation apparatus controls a vehicle based on an operation signal transmitted from a portable terminal of a user through a service center. A time comparing part compares a first reception time, at which the service center receives the operation signal from the portable terminal, with an operation time at which the user performs a remote operation. A discarding part discards the operation signal when a difference between the reception time and the operation time, as a result of a comparison by the time comparing part, is equal to or longer than a predetermined time period.

### TECHNICAL FIELD

The present invention relates remote control techniques of in-vehicle equipments and, more particularly, to a remote operation apparatus (or a remote control apparatus) for operating an in-vehicle equipment in accordance with an operation performed at a remote place and a service center for mediating transmission of an operation performed at a remote place to an in-vehicle equipment.

### BACKGROUND ART

There is suggested a remote control technique for operating an in-vehicle equipment by a portable terminal, which is carried by a driver, through a service center. Using such a remote control technique, it is possible to control an operation of an in-vehicle equipment from a remote place, such as locking or unlocking a vehicle door and opening or closing a vehicle window, controlling a vehicle security function, starting an engine, or the like (for example, refer to Patent Document 1).

In a case of a remote operation, an arrival time of an operation signal transmitted from a portable terminal cannot be constant due to a fluctuation in a radio propagation condition, a degree of a load applied to a relay point, or the like. If it takes a long time from an operation of the portable terminal until the in-vehicle equipment is actually operated, there may be a case where a condition surrounding the vehicle is changed, which causes an unexpected problem.

In order to solve such a problem, there is suggested a remote control apparatus, which measures a distance between a driver and a vehicle in accordance with an arrival time of an operation signal so as to prohibit a remote operation when the measured distance is larger than a predetermined distance (for example, refer to Patent Document 2). The remote control apparatus disclosed in Patent Document 2 aims to limit an operation causing a problem by determining rights and wrongs of a control of an in-vehicle equipment in accordance with a kind of the operation signal and a distance between a vehicle and a remote control device even if a radio arrives and a remote operation can be performed.

Patent Document 1: Japanese Laid-Open Patent Application 2004-102939

Patent Document 2: Japanese Laid-Open Patent Application No. 6-55936

However, the remote control apparatus disclosed in Patent Document 2 operates an in-vehicle equipment by transmitting radio frequency directly from a portable terminal to a vehicle without going through a service center. Thus, it is difficult to accurately measure an arrival time since a radio propagation distance is short. Additionally, even if the measurement is possible, it is required to synchronize a clock of the portable terminal with a clock of the vehicle, thereby increasing a cost due to necessity of a system for acquiring synchronization.

Moreover, in a case where a remote operation is performed without going through a service center, there is little possibility that a radio wave does not reach the vehicle. Thus, a state where a radio wave does not actually reach when a remote operation is performed by a portable terminal, that is, a state where a so-called timeout occurs is not considered in the remote control apparatus of Patent Document 2.

When performing a remote operation through a service center, depending on a location of a vehicle, an operation signal may not reach the vehicle, and a delay may occur according to a load condition of the service center, a radio propagation condition, or the like. If a delay occurs in the remote operation, a time lag is generated between a desired operation timing of a user and a control timing of the in-vehicle equipment, which is not preferable.

Moreover, since a driver cannot visually check the vehicle condition when performing a remote operation through a service center, the driver wants to check early whether or not the remote operation is reflected in the in-vehicle equipment. However, there is a case where a considerable time is taken until a notification of a result of the operation is sent to the driver depending on a radio condition or whether or not a radio wave reaches the vehicle. In such a case, the driver cannot confirm whether the remote operation was actually performed, and cannot start a subsequent action.

### SUMMARY OF THE INVENTION

It is a general object of the present invention to provide an improved and useful remote operation system in which the above mentioned problems are eliminated.

A more specific object of the present invention is to provide a remote operation apparatus and a service center, which are capable of determining an occurrence of timeout and accurately sending a notification of a result of a remote operation to a driver.

In order to achieve the above-mentioned objects, there is provided according to one aspect of the present invention a remote operation apparatus for controlling a vehicle based on an operation signal transmitted from a portable terminal of a user through a service center, the remote operation apparatus comprising: a time comparing part that compares a first reception time, at which the service center receives the operation signal from the portable terminal, with an operation time at which the user performs a remote operation; and a discarding part that discards the operation signal when a difference between the reception time and the operation time, as a result of a comparison by the time comparing part, is equal to or longer than a predetermined time period.

Additionally, there is provided according to another aspect of the present invention a remote operation apparatus for controlling a vehicle based on an operation signal transmitted from a portable terminal of a user through a service center, the remote operation apparatus sends to the user a timeout notification indicating that an operation of the user was timeout when a predetermined time period is longer than a timeout period, where the predetermined time period is one of or a sum of two or more of: a) a time period for processing the operation signal in the service center; b) a time period from a signal transmission time at which the service center transmits the operation signal to the vehicle and until a time at which the vehicle receives the operation signal; c) a time period for processing the operation signal by the vehicle; and d) a time period from a completion notification time at which the vehicle sends a notification signal indicating a completion of a control of an in-vehicle device and until a time at which the service center receives the notification signal.

Additionally, there is provided according to another aspect of the present invention a service center that relays and transmits an operation signal, which is transmitted from a portable terminal used by a user, to a vehicle, the service center comprising a discarding part that discards the operation signal when the operation signal does not reach the vehicle.

Further, there is provided according to another aspect of the present invention, a service center that relays and transmits an operation signal, which is transmitted from a portable terminal used by a user, to a vehicle, the service center sends to the user a timeout notification indicating that an operation of the user was timeout when a predetermined time period is longer than a timeout period, where the predetermined time period is one of or a sum of two or more of: a) a time period for processing the operation signal in the service center; b) a time period from a signal transmission time at which the service center transmits the operation signal to the vehicle and until a time at which said vehicle receives the operation signal; c) a time period for processing the operation signal by the vehicle; and d) a time period from a completion notification time at which the vehicle sends a notification signal indicating a completion of a control of an in-vehicle device and until a time at which the service center receives the notification signal.

According to the present invention, the remote operation apparatus and the service center determine an occurrence of timeout and send a notification of a result of operation to a user or driver accurately.

Other objects, features and advantages of the present invention will become more apparent from the following detailed description when read in conjunction with the accompanying drawings.

### BRIEF DESCRIPTION OF THE DRAWINGS

FIG. 1 is an illustration of a remote operation system for controlling an in-vehicle equipment by an operation signal transmitted by a portable device carried by a user through a service center;

FIG. 2 is a functional block diagram of the service center;

FIG. 3 is a functional block diagram of a remote operation device equipped to a vehicle;

FIG. 4 is an activity diagram showing a process of the remote operation system to discard an operation signal by the vehicle when timeout occurs in an operation made by a user;

FIG. 5 is an activity diagram showing a process of the remote operation system to discard an operation signal by the service center when timeout occurs in an operation made by a user;

FIG. 6 is a sequence diagram showing a process time of each process from a remote operation request made by a user until the user receives a completion notification;

FIG. 7 is a graph of a normal distribution of a user waiting time; and

FIG. 8 is an activity diagram of the remote operation system when detecting timeout based on a previously set timeout period.

### BEST MODE FOR CARRYING OUT THE INVENTION

A description will be given below, with reference to the drawings, of embodiments of the present invention.

### First Embodiment 1

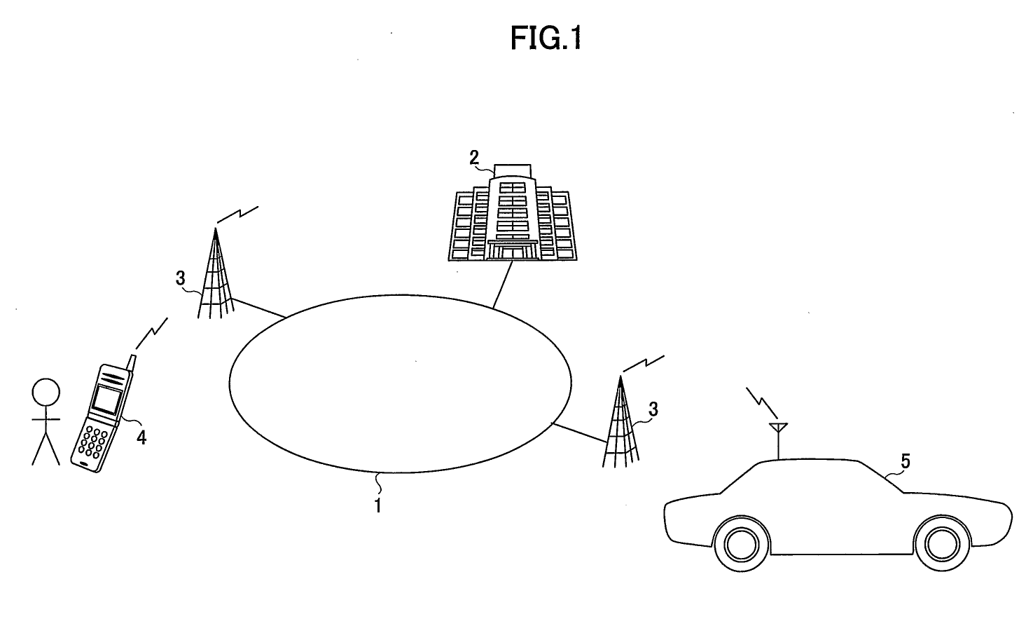

FIG. 1 is an illustration of an entire remote operation system in which an operation signal is transmitted from a portable terminal 4, which is carried by a user, to a vehicle 5 through a service center 2 and the vehicle 5 controls an in-vehicle device in accordance with the operation signal.

The remote operation system (or a remote control system) comprises the service center 2 managing operation states of a plurality of equipments mounted on the vehicle 5, the vehicle 5 remote-operated by a user, and the portable terminal 4 carried by the user. The service center 2 is connected to a network 1 such as the Internet or the like. The vehicle 5 and the portable terminal 4 are communicable with base stations 3 connected to the network 1. It should be noted that the user is a person using the remote operation system, which is registered in the service center 2 and capable of operating the vehicle 5 through the portable terminal 4, that is, for example, the user is a driver of the vehicle 5.

In the remote operation system, the operation signal input through the portable terminal 4 is transmitted to the vehicle 5 through the service center 2, and the vehicle 5 controls an in-vehicle device in accordance with the operation signal. In the present embodiment, when timeout occurs in an operation of the portable terminal 4 made by the user, the operation signal is discarded so that the in-vehicle device is not controlled in accordance with the operation signal. Although described later, the timeout refers to a state where a time period (or a time interval) exceeding a predetermined time period has passed after a user operation was made and until the in-vehicle device is controlled in accordance with the user operation.

The portable terminal 4 can be a cellular phone, a portable computer, an electronic notebook (Personal Digital Assistant (PDA)), a PHS (Personal Handyphone System) terminal, etc. That is, the portable terminal 4 can be any equipments, which can be connected to the service center 2 through the network 1 and are capable of performing an operation requested by the service center 2.

A description will now be given of the service center 2. The service center 2 provides various services to the user through the vehicle 5 and the portable terminal 4. According to the services provided by the service center 2, it is possible to notify the user of an intrusion of an unauthorized person into the vehicle 5 or an engine start operation made by an unauthorized person by monitoring the invasion or the engine start operation, and also possible to operate an in-vehicle device in the vehicle 5.

The service center 2 includes a computer consisting of a CPU, a ROM, a RAM, a memory device, a communication device, etc., and is communicable with the portable terminal 4 and the vehicle 5.

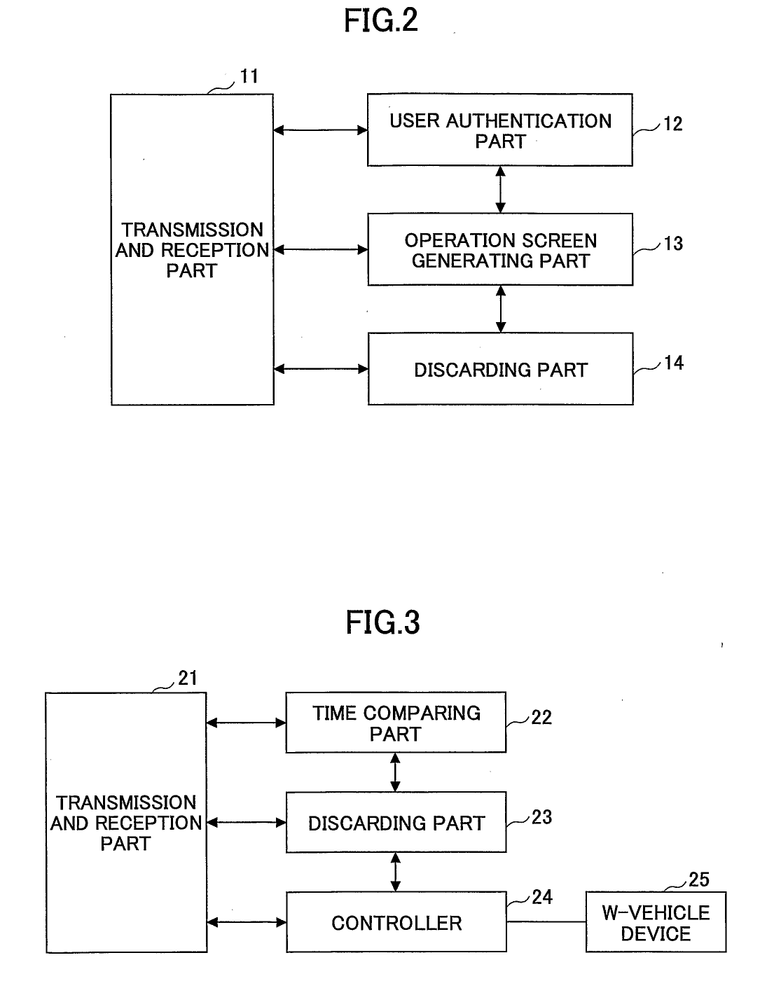

FIG. 2 is a functional block diagram of the service center 2. The service center 2 includes a transmission and reception part 11, a user authentication part 12, an operation screen generating part 13 and a discarding part 14.

The transmission and reception part 11 communicates with the portable terminal 4 and the vehicle 5 through the network 1. The transmission and reception part 11 receives an operation signal transmitted from the portable terminal 4, and transmits the operation signal, which is processed by the service center 2, to the vehicle 5. Additionally, the transmission and reception part 11 receives a completion notification, which indicates a completion of an operation of an in-vehicle device, and an operation discard notification, which notifies discarding of an operation signal, transmitted by the vehicle, and transmits the completion notification and the operation discard notification, which have been processed in the service center 2, to the portable terminal 4.

When communicating with vehicles 5, it is preferable for the transmission and reception part 11 to use the short message service (hereinafter, referred to as SMS) used in a digital cellular phone network. Although the SMS can be used with a cellular-phone network such as the PDC (Personal Digital Cellular), the GSM (Global System for Mobile Communications), the CDMA (Code Division Multiple Access), etc., the form of the cellular-phone network is not limited. In the SMS, when the vehicle 5 is within a cover area of the base station 3, the service center 2 can acquire an arrival notification of an operation signal from the base station 3 in a short time. It should be noted that the communication means between the vehicle 5 and the service center 2 can use any communication methods if a response can be made in a short time.

When the user accesses the service center 2 using the portable terminal 4, the user authentication part 12 requests an input of a user ID and a password so as to authenticate the user according to consistency between the input user ID and the input password.

The user authentication part 12 extracts a user ID and a password by referring to a user information database (DB) in which user information of users of the remote operation system is registered. The user information DB stores pieces of information regarding a contract ID, which is given for each contract when making the contract, a user ID, which discriminates each user, a name, an address, a phone number, sex, age, a password, etc. It should be noted that live-body discriminating information such as a fingerprint, a voiceprint, a contour of one's face, an iris, a venous pattern, etc., may be used for the user authentication.

The operation screen generating part 13 produces an operation menu, which a user can select, in accordance with contents of a contract with the user by using HTML (HyperText Markup Language), XML (eXtensible Markup Language), etc.

The discarding part 14 discards an operation signal in a case where an arrival signal is not received from the vehicle 5 after the transmission and reception part 11 transmits the operation signal to the vehicle 5 using the SMS. The discarding of the operation signal is made by causing the transmission and reception part 11 to stop the transmission of the operation signal to the vehicle 5. It should be noted that although the SMS has a communication mode to resend an operation signal when the vehicle 5 enters a communicable range and set in a communicable state, a timeout is detected when no arrival notification is received even when an operation signal is transmitted for a predetermined number of times so that the discarding part 14 causes the base station 3 to stop the transmission of the operation signal to the vehicle 5.

Moreover, the discarding part 14 notifies a user of the fact that a timeout was detected and the operation signal was discarded. That is, the discarding part 14 produces a message indicating that the operation signal was discarded, and the transmission and reception part 11 transmits the message to the portable terminal 4.

A description will now be given of the vehicle 5. FIG. 3 shows a functional block diagram of a remote operation device provided in the vehicle 5. The remote operation device comprises a transmission and reception part 21, a time comparing part 22, a discarding part 23, a controller 24 and an in-vehicle device 25.

The transmission and reception part 21 receives an operation signal transmitted by the service center 2 by a reception circuit, and restores' the received operation signal. The restored operation signal is sent to the controller 24, and the controller 24 determines the contents of the operation made by a driver so as to control the in-vehicle device 25 in accordance with a result of the determination.

The in-vehicle device 25 is, for example, a door, a window, a slide roof, a security device, an engine ECU or the like. The controller 24 drives an actuator for opening and closing the door, the window or the slide roof in accordance with the operation signal, and also controls ON/OFF of an air-conditioner or a security function.

The time comparing part 22 compares an operation time of performing a remote-operation by a user with a reception time of receiving the operation signal by the vehicle 5. The operation time of performing a remote-operation by a user is a signal reception time when the service center 2 receives the operation signal, or a signal transmission time when the service center 2 transmits the operation signal to the vehicle 5. It should be noted that the operation time of performing a remote-operation by a user may be a time when the operation signal is transmitted by the user operating the portable terminal 4.

It should be noted that the vehicle 5 and the service center 2 has clocks, respectively, which are in synchronization with each other with an accuracy sufficient for determining a timeout. The timeout in the present embodiment is determined based on whether or not a difference (a time interval) between the operation time and the reception time is equal to or greater than a predetermined time period, and, thus, the timeout period can be set to a sufficiently long period (for example, more than 1 second) as compared to an arrival period of an operation signal (radio wave). Accordingly, a high accuracy is not required for the synchronization of the clocks of the vehicle 5 and the service center 2.

If the difference (time interval) between the operation time and the reception time is equal to or greater than the timeout period, the discarding part 23 of the remote operation device detects a timeout and discard the operation signal. When the operation signal is discarded, the discarding part 14 limits the operation of the in-vehicle device based on the operation signal concerned, and sends a notification to a user through the service center 2 that the operation signal was discarded.

It should be noted that the vehicle 5 is provided with a GPS (Global Positioning System) equipment so as to detect a present position based on an arrival time of satellite positioning information sent from a GPS satellite and orbit information of the GPS satellite. If a user of the remote operation system wants to know a position of the vehicle 5, the user can display the position of the vehicle 5 with a map on a display screen of the portable terminal 4.

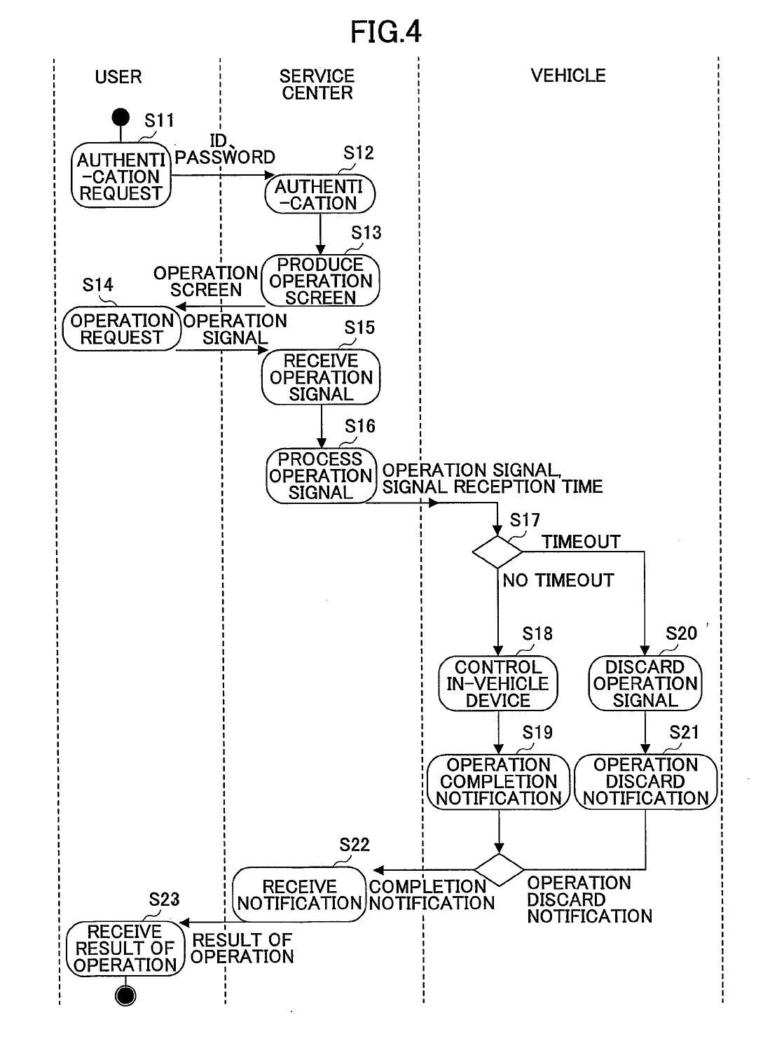

A description will now be given, with reference to FIG. 4, of a process of the remote operation system to discard an operation signal when an operation of a user is timeout using the above-mentioned structure. FIG. 4 is an activity diagram of a process to discard an operation signal by the discarding part 23.

First, an access is made from the portable terminal 4 to the service center 2 so as to make an authentication request to the service center 2 (step S11). The service center 2 refers to the user information DB, and authenticates a user based on a user ID and a password sent from the portable terminal 4 (step S12). Then, the operation screen generating part 13 produces an operation screen (step S13), and sends information regarding the operation screen to the portable terminal 4.

When the driver (user) selects a desired operation through the portable terminal 4, the operation signal transmitted by the portable terminal 4 is sent to the service center 2 through a cellular-phone network or the network 1 (step S14).

When the transmission and reception part 11 receives the operation signal transmitted by the portable terminal 4, the transmission and reception part 11 records a signal reception time at which the operation signal is received (step S15). Then, the service center 2 performs a process to transmit the operation signal to the vehicle 5 (step S16). For example, the process applied to the operation signal is to change the operation signal into a form appropriate for the vehicle 5 or to produce the SMS. A delay may be generated in such a process due to a large load when process requests from other users or other service requests are made simultaneously or in a short time. Then, the transmission and reception part 11 transmits the operation signal to the vehicle 5 with the signal reception time being attached to the operation signal.

When the transmission and reception part 21 of the vehicle 5 receives the operation signal, the transmission and reception part 21 records a reception time. The time comparing part 22 compares the signal reception time attached to the operation signal with the reception signal, and determines whether or not the user operation is timeout based on whether or not a difference between the signal reception time and the reception time is equal to or longer than a timeout period (for example, 1 to 10 seconds) (step S17).

If it is determined that no timeout occurs, the controller controls the in-vehicle device 25 in accordance with the operation signal (step S18). Additionally, the controller 24 produces a completion notification indicating a completion of the control of the in-vehicle device 25, and sends the completion notification to the service center 2 (step S19).

If it is determined that a timeout occurs, the discard part 23 discards the operation signal (step S20). That is, if a time period longer than a predetermined time period has passed after the service center 2 received the operation signal and until the transmission of the vehicle 5 was made, the operation signal is discarded. The discarding part 23 limits the control of the in-vehicle device 25 by the controller 24. Thus, if a considerable time period has passed such that it is assumed that the user's intention cannot be reflected, an operation of the in-vehicle device 25 can be limited. The discarding part 23 sends to the service center 2 an operation discard notification indicating the discarding of the operation signal (step S21).

The service center 2 receives the completion notification or the operation discard notification (step S22) and sends the notification to the user (step S23).

Accordingly, if the vehicle 5 determines an occurrence of timeout as shown in FIG. 4, the in-vehicle device 25 cannot be operated when a considerable time period has passed such that the user's intention is not reflected since the vehicle 5 discards the operation signal even if the operation signal is reached after a delay is generated in the process of the service center 2.

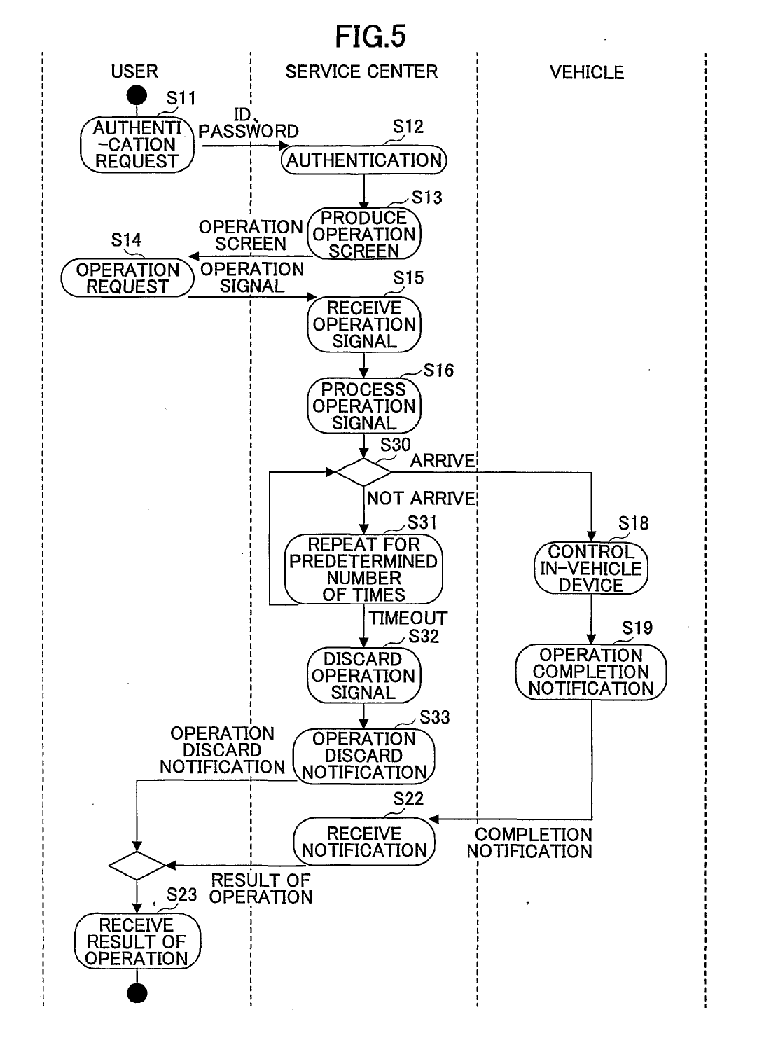

Moreover, the service center 2 may discard the operation signal. A description will now be given, with reference to FIG. 5, of a process of the remote operation system to discard an operation signal when an operation by a user runs out of time. FIG. 5 is an activity diagram of a process of the discarding part 14 of the service center 2 to discard an operation signal. In FIG. 5, steps that are the same as the steps shown in FIG. 4 are given the same step numbers.

First, the user accesses the service center 2 through the portable terminal 4 so as to request an authentication to the service center 2 (step S11). The service center 2 refers to the user information DB, and authenticates the user based on a user ID and a password sent from the portable terminal 4 (step S12). The operation screen generating part 13 produces an operation screen (S13), and the transmission and reception part 11 transmits information regarding the operation screen to the portable terminal 4.

If the driver (user) selects a desired operation through the portable terminal 4, the operation signal transmitted from the portable terminal 4 is sent to the service center 2 through a cellular-phone network or the network 1 (step S14)

When the transmission and reception part 11 receives the operation signal transmitted from the portable terminal 4, the transmission and reception part 11 records a signal reception time, which is a time of reception of the operation signal (step S15). It should be noted that since the signal reception time is not used for discarding the operation signal in the process of FIG. 5, the signal reception time may not be recorded.

Subsequently, the service center 2 performs a process for sending the operation signal to the vehicle 5 (step S16). For example, the process applied to the operation signal is to change the operation signal into a form appropriate for the vehicle 5 or to produce the SMS. A delay may be generated in such a process due to a large load when process requests from other users or other service requests are made simultaneously or in a short time. Then, the transmission and reception part 11 transmits the operation signal to the vehicle 5 with the signal reception time being attached to the operation signal.

The transmission and reception part 11 transmits the operation signal to the vehicle 5 by using the SMS provided by the cellular-phone network (step S30). According to the SMS, the service center 2 can receive immediately an arrival notification from the vehicle when the vehicle is in a communicable range. Thus, if the operation signal does not reach the vehicle 5 (if an arrival notification is not received), the transmission of the operation signal is repeated for a predetermined number of times (step S31). Then, if the operation signal does not reach the vehicle 5, the service center 2 determines that a timeout occurs and discards the operation signal (step S32). The discarding part 14 causes the transmission and reception part 11 to stop the transmission of the operation signal to the vehicle 5.

On the other hand, if the operation signal reaches the vehicle 5, similar to the process of FIG. 4, the controller 24 of the vehicle 5 controls the in-vehicle device 25 in accordance with the operation signal (step S18). Additionally, the controller 24 produces a completion notification indicating that the operation of the in-vehicle device 25 was completed, and sends the completion notification to the service center 2 (step S19). Then, the service center 2 receives the completion notification (step S22).

Subsequently, the service center 2 sends the completion notification or the operation discard notification to the user, and the user receives a notification of a result of the operation (step S23)

Therefore, the user is notified of a timeout if the vehicle 5 is not in a communication range of the SMS since a determination of the timeout is made based on the number of times of the transmission of the operation signal when the operation signal itself does not reach the vehicle 5 as in the process of FIG. 5. Additionally, even if the vehicle 5 enters the communication range of the SMS after a time has passed, the in-vehicle device 25 is not operated.

It should be noted that although the service center 2 determines an occurrence of timeout in the process of FIG. 5, a determination of an occurrence of timeout may be performed by the vehicle 5 in addition to the determination made by the service center 2. By making a determination also by the vehicle 5, the determination of an occurrence of timeout can be made and the operation signal can be discarded even if the operation signal reaches the vehicle 5 after a delay occurs in the process of the service center 2.

As mentioned above, according to the present embodiment, the concept of timeout is introduced into the user's operation in the remote operation system to control an in-vehicle device of a vehicle from a remote place so that if a considerable time has passed from a time of carrying out the user's operation, the operation can be cancelled on the assumption that the user's intention cannot be reflected.

### Second Embodiment

The remote operation system, in which the concept of timeout is introduced and the in-vehicle device of the vehicle 5 is not operated, was explained in the first embodiment, and setting of the timeout period will be explained in the second embodiment.

Since a user cannot visually check the vehicle 5 when the user performs a remote operation, the user wants to check whether or not the control according to the user's operation was performed on the in-vehicle device as soon as possible. Thus, in the remote operation system, it is preferable to notify the user of an occurrence of timeout. However, if the timeout period is set to a short time, a number of remote operations that runs out of time may be increased, which is not preferable. Thus, it is preferable that the timeout period is set so that a large part of the remote operations do not run out of time but a determination of timeout is made when there is a high possibility that a long time is taken until a notification is sent to a user.

In the present embodiment, statistics of a time until the vehicle 5 starts controlling an in-vehicle device is taken so as to set the timeout period to a time period with which a remote operation does not run out of time at a predetermined probability and a notification can be sent to a user quickly.

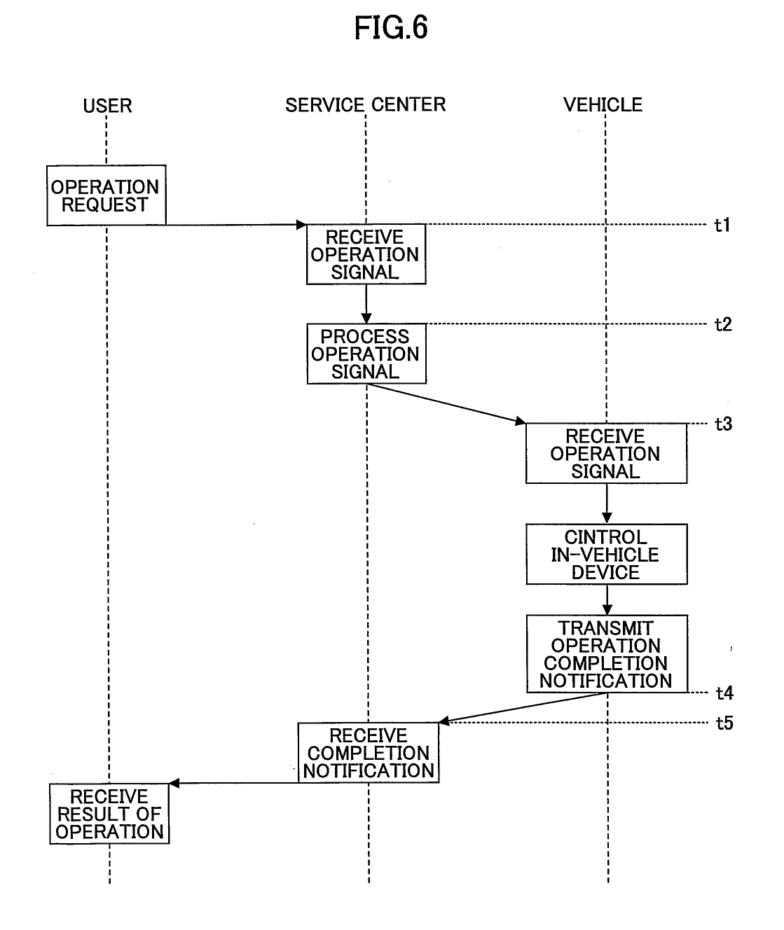

FIG. 6 is a sequence chart showing a process time of each process from a time when the remote operation request is made by a user and until the user receives the completion notification. FIG. 6 shows each process time and each transmission time during a period from the time when the service center 2 receives an operation signal and the in-vehicle device is operated in the vehicle 5 and until the service center 2 receives the completion notification.

Specifically, the sum total of process time periods and transmission time periods classified as explained below is a waiting time until the completion notification is sent to the user. Hereinafter, the total of a) to d) is referred to as a user waiting time.

a) a time period of processing an operation signal at the service center (center processing period):

a time interval between a time t1 at which the service center 2 receives the operation signal and a time t2 at which the operation signal is transmitted to the vehicle 5

b) a time period of transmitting a request (request transmitting period);

a time interval between the time t2 at which the operation signal is transmitted and a time t3 at which the vehicle 5 receives the operation signal

c) a time period of processing in the vehicle (vehicle processing period):

a time interval between the time t3 at which the vehicle 5 receives the operation signal and a time t4 at which the vehicle 5 transmits the completion notification

d) a time period of sending a notification of a result (result notification period):

a time interval between the time t4 at which the vehicle 5 transmits the completion notification and a time at which the service center 2 receives the completion notification

The service center 2 statistically processes the user waiting time by setting the user waiting times of a predetermined number of remote operations as a population parameter of samples. If the parameter is sufficiently large, the user waiting time falls into a normal distribution.

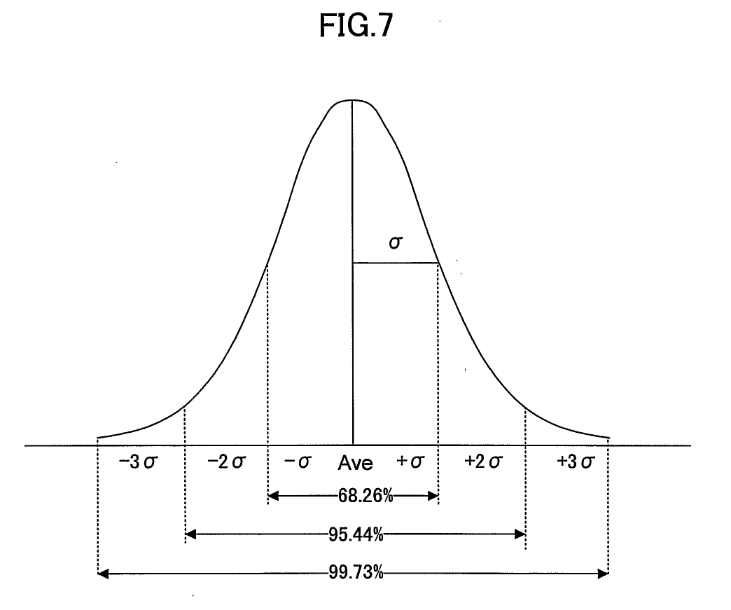

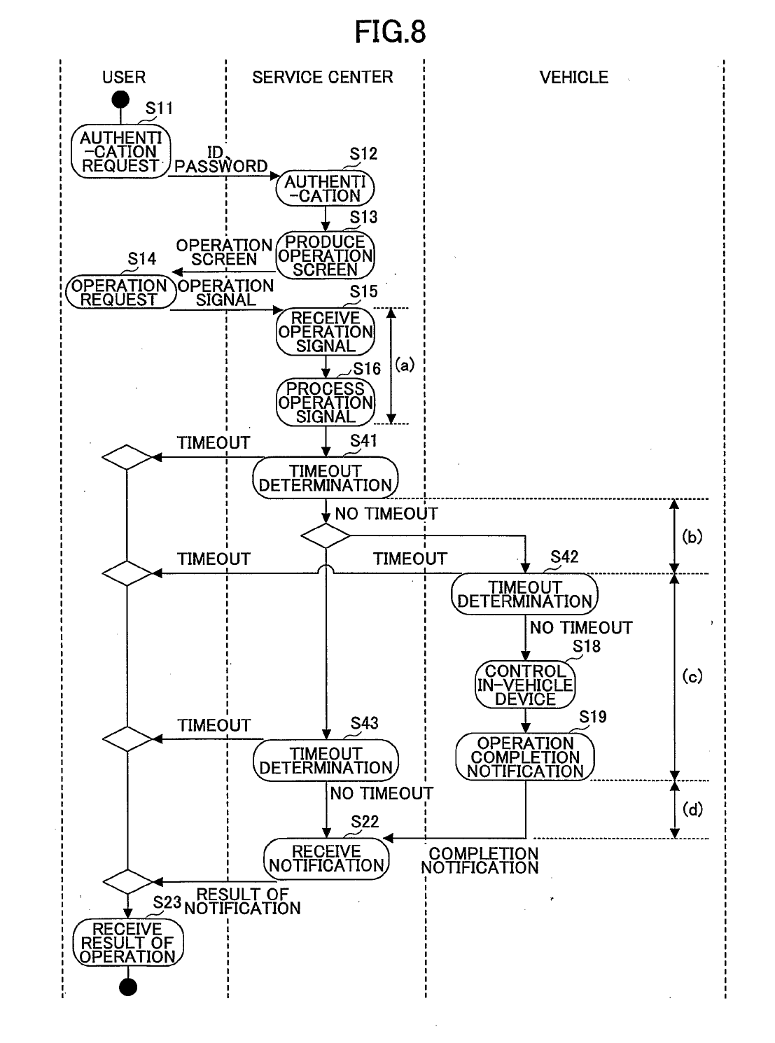

FIG. 7 shows the normal distribution curve of the user waiting time. In FIG. 7, an X-axis represents a deviation of the user waiting time from the average Ave, and a Y-axis represents a probability, and an area encircled by the X axis and the normal distribution curve is 1.

If a standard deviation is set to σ, it is known that the probability that the user waiting time falls into a range of ±1σ from the average Ave is 68.26%. Similarly, it is known that the probability that the user waiting time falls into a range of ±2σ from the average Ave is 95.44%, and the probability of ±3σ is 99.73%.

As mentioned above, the timeout period is set to a period at which remote operations do not run out of time and a notification can be sent to the user quickly. For example, if a remote operation must be performed positively even if a user have to wait for a short time when a timeout occurs, the average Ave+σ is set to the timeout period. In such a case, the period from the time t1 at which the service center 2 receives the operation signal and until the time t5 at which the service center 2 receives the operation signal exceeds the average Ave+3signa, the service center 2 determines that a timeout has occurred. If the timeout period is set to the average Ave+3σ, 99.73% of the remote operations are not determined as timeout.

Moreover, if, for example, a notification of an occurrence of timeout should be sent to a user quickly, the timeout period is set to the average Ave+2σ. In such a case the period from the time t1 at which the service center 2 receives the operation signal and until the time t5 at which the service center 2 receives the operation signal exceeds the average Ave+2σ, the service center 2 determines that a timeout has occurred. If the timeout period is set to the average Ave+2σ, 95.44% of the remote operations are not determined as timeout.

By statistically processing the user waiting time as mentioned above, the timeout period can be appropriately set. It should be noted that although a normal distribution is used in the above-mentioned process as shown in FIG. 7, an appropriate timeout period can be set by statistically processing the user waiting time in the present embodiment. Thus, if the user waiting time falls into other distributions (t-distribution, x²-distribution, F-distribution, etc.), the timeout period may be set in accordance with those distributions.

In the meantime, since statistical processing can be applied to each of the process periods a) to d) or each of the transmission times, and the determination of timeout may be performed on each of the process periods a) to d) or each of the transmission times. If statistical processing is performed on each of a) to d), an occurrence of timeout can be determined for each of the times t2 to t4 as follows.
if the center processing period is longer than (an average of the center processing period+3σ) at the time t2;
if (the center processing period+the request transmitting period) is longer than (the average of the center processing periods+the average of the request transmitting periods+3σ′) at the time t3. It should be noted that 3σ′ is 3σ of (the average of the center processing periods+the average of the request transmitting periods).
if (the center processing period+the request transmitting period+vehicle processing period) is longer than (the average of the center processing periods+the average of the request transmitting periods+the average of the vehicle processing periods+3σ″) at the time t4. It should be noted that 3σ″ is 3σ of (the average of the center processing periods+the average of the request transmitting periods+the average of the vehicle processing periods).

Thus, if an occurrence of timeout is determined for each of the processing periods a) to d) or each of the transmitting times and the user is notified of the result of the determination at the time when the timeout occurs, the notification of the timeout can be sent to the user quickly.

FIG. 8 is an activity diagram of a process of the remote operation system to detect timeout based on the timeout period previously set. In FIG. 8, steps that are the same as the steps shown in FIG. 4 are give the same step numbers, and descriptions thereof will be simplified. Additionally, the alphabets (a) through (d) shown in FIG. 8 correspond to the above-mentioned periods a) through d), respectively.

First, the user accesses the service center 2 through the portable terminal 4 so as to request an authentication to the service center 2 (step S11). The service center 2 refers to the user information DB, and authenticates the user based on a user ID and a password sent from the portable terminal 4 (step S12). The operation screen generating part 13 produces an operation screen (S13), and the transmission and reception part 11 transmits information regarding the operation screen to the portable terminal 4.

If the driver (user) selects a desired operation through the portable terminal 4, the operation signal transmitted from the portable terminal 4 is sent to the service center 2 through a cellular-phone network or the network 1 (step S14)

When the transmission and reception part 11 receives the operation signal transmitted from the portable terminal 4, the transmission and reception part 11 records a signal reception time, which is a time of reception of the operation signal (step S15). Subsequently, the service center 2 performs a process for sending the operation signal to the vehicle 5 (step S16).

Then, the service center 2 determines an occurrence of timeout based on whether or not the center processing period is longer than (the average of the center processing period+3σ) (step S41). If it is determined that a timeout has occurred, a timeout notification is sent to the user.

If no timeout has occurred, the service center 2 transmits the operation signal to the vehicle 5. Upon reception of the operation signal, the vehicle 5 determined an occurrence of a timeout based on whether or not (the center processing period+the request transmitting period) is longer than (the average of the center processing periods+the average of the request transmitting periods+3σ′) (step S42). If it is determined that a timeout has occurred, a timeout notification is sent to the user.

On the other hand, if no timeout has occurred, the controller 24 of the vehicle 5 controls the in-vehicle device 25 in accordance with the operation signal (step S18). Additionally, the controller 24 produces a completion notification indicating that the operation of the in-vehicle device 25 was completed, and sends the completion notification to the service center 2 (step S19).

Additionally, concurrently to the control of the in-vehicle device in the vehicle 5, the service center 2 determines an occurrence of timeout (step S43). That is, if the timeout period (the average of the center processing periods+the average of the request transmitting periods+the average of the result notification periods+3σ″) has passed from the signal reception time, the service center 2 determines that a timeout has occurred. On the other hand, if the completion notification is received from the vehicle 5, it is not an occurrence of timeout, and a determination of timeout is not made (step S22). Then, the service center 2 sends the completion notification or the timeout notification to the user, and the process of FIG. 8 is ended (step S23).

It should be noted that there may be a case where the completion notification is transmitted from the vehicle 5 after the occurrence of timeout is determined in step S43 although it is a low probability. In such a case, the completion notification indicating that the in-vehicle device was operated is sent to the user after the timeout notification is sent.

By setting the timeout period as shown in FIG. 8, an occurrence of timeout can be determined for each of processing periods a) through d) or at each of the transmission times. Thus, a notification of an occurrence of timeout can be sent to the user quickly. Since the user can receive the timeout notification quickly after performing an operation, the user can perform a subsequent operation quickly.

According to the present embodiment, a remote operation does not run out of time with a predetermined probability, and the timeout period can be set to a period with which a notification can be sent to the user quickly. Additionally, the timeout notification can be sent to the user quickly based on the thus-set timeout period.

The present invention is not limited to the specifically disclosed embodiments, and variations and modifications may be made without departing from the scope of the present invention.

The present application is based on Japanese priority application No. 2005-175289 file Jun. 15, 2005, the entire contents of which are hereby incorporated herein by reference.

1. A remote operation apparatus for controlling a vehicle based on an operation signal transmitted from a portable terminal of a user through a service center, said remote operation apparatus comprising:
a time comparing part that compares a first reception time, at which said service center receives the operation signal from said portable terminal, with an operation time at which said user performs a remote operation; and
a discarding part that discards the operation signal when a difference between said reception time and said operation time, as a result of a comparison by said time comparing part, is equal to or longer than a predetermined time period.

2. The remote operation apparatus as claimed in claim 1, wherein said operation time is one of a signal reception time at which said service center receives said operation signal and a signal transmission time at which said service center transmits said operation signal to said vehicle.

3. The remote operation apparatus as claimed in claim 1, wherein said discarding part sends a notification, which indicates that the operation signal was discarded, to said user.

4. A remote operation apparatus for controlling a vehicle based on an operation signal transmitted from a portable terminal of a user through a service center, the remote operation apparatus sends to said user a timeout notification indicating that an operation of said user was timeout when a predetermined time period is longer than a timeout period, where said predetermined time period is one of or a sum of two or more of:
a) a time period for processing the operation signal in said service center;
b) a time period from a signal transmission time at which said service center transmits the operation signal to said vehicle and until a time at which said vehicle receives the operation signal;
c) a time period for processing the operation signal by said vehicle; and
d) a time period from a completion notification time at which said vehicle sends a notification signal indicating a completion of a control of an in-vehicle device and until a time at which said service center receives the notification signal.

5. The remote operation apparatus as claimed in claim 4, wherein said timeout period is determined based on statistics on each of the time periods of a) through d) so that an operation of said user does not run out of time with a predetermined probability.

6. The remote operation apparatus as claimed in claim 5, wherein said timeout period is determined based on an average time period and a standard deviation of each of the time periods a) through d) that are calculated statistically so that said timeout period is within three times of a standard deviation of each average time period or within three times of a standard deviation of a total average time period, which is a sum of two or more of the average time period.

7. A service center that relays and transmits an operation signal, which is transmitted from a portable terminal used by a user, to a vehicle, the service center comprising a discarding part that discards the operation signal when the operation signal does not reach said vehicle.

8. The service center as claimed in claim 7, further comprising an arrival reception part that receives an arrival notification with respect to the operation signal from said vehicle, and wherein said discarding part discards the operation signal when said arrival reception part does not receive the arrival notification signal by repeating a transmission of the operation signal for a predetermined times.

9. The service center as claimed in claim 7, wherein said discarding part sends to said user a notification indicating that the operation signal was discarded.

10. A service center that relays and transmits an operation signal, which is transmitted from a portable terminal used by a user, to a vehicle, the service center sends to said user a timeout notification indicating that an operation of said user was timeout when a predetermined time period is longer than a timeout period, where said predetermined time period is one of or a sum of two or more of:
a) a time period for processing the operation signal in said service center;
b) a time period from a signal transmission time at which said service center transmits the operation signal to said vehicle and until a time at which said vehicle receives the operation signal;
c) a time period for processing the operation signal by said vehicle; and
d) a time period from a completion notification time at which said vehicle sends a notification signal indicating a completion of a control of an in-vehicle device and until a time at which said service center receives the notification signal.

11. The service center as claimed in claim 10, wherein said timeout period is determined based on statistics on each of the time periods of a) through d) so that an operation of said user does not run out of time with a predetermined probability.

12. The service center as claimed in claim 11, wherein said timeout period is determined based on an average time period and a standard deviation of each of the time periods a) through d) that are calculated statistically so that said timeout period is within three times of a standard deviation of each average time period or within three times of a standard deviation of a total average time period, which is a sum of two or more of the average time period.
